(19) United States
(12) Patent Application Publication
(10) Pub. No.: US 2024/0393745 A1
(43) Pub. Date: Nov. 28, 2024

(54) METHOD FOR MANUFACTURING A DIAL OF A WATCH

(71) Applicant: OMEGA SA, Biel/Bienne (CH)

(72) Inventors: Sébastien Laissue, Métabief (FR); Pierre Sauret, Les Hauts-Geneveys (CH); Giovanni Poly, Charquemont (FR); Frédéric Jeanrenaud, La Chaux-de-Fonds (CH); Gregory Kissling, La Neuveville (CH)

(73) Assignee: OMEGA SA, Biel/Bienne (CH)

(21) Appl. No.: 18/644,383

(22) Filed: Apr. 24, 2024

(30) Foreign Application Priority Data
May 25, 2023 (EP) 23175384.9

(51) Int. Cl. G04D 3/00

(52) U.S. Cl. CPC G04D 3/0092

(57) ABSTRACT

A method for manufacturing a dial (2) of a watch (1) including a visible face (11) having a small surface, the face (11) comprising a three-dimensional representation (3) of a topographic map of the landscape, the method comprising the following steps of: producing (20) a blank (12) of the dial (2) comprising an upper face (13) provided with a three-dimensional structure (5) relating to the three-dimensional representation (3) of the landscape, the production step (20) comprising a sub-step (22) of generating topographic data for constructing the three-dimensional structure (5) in the upper face (13); treating (29) a surface (14) of the three-dimensional structure (5) of the upper face (13) of the blank (12) during which at least one visual feature of the surface (14) is modified in anticipation of obtaining the three-dimensional representation (3); and finishing (35) the blank (12) to obtain the dial (2).

### CROSS REFERENCE TO RELATED APPLICATIONS

This application claims priority to European Patent Application No. 23175384.9 filed May 25, 2023, the entire contents of which are incorporated herein by reference.

### TECHNICAL FIELD OF THE INVENTION

This invention relates to a method for manufacturing a dial of a watch, which dial comprises a decoration including a three-dimensional representation of a landscape.

The invention further relates to such a dial and to a watch provided with this dial.

### TECHNOLOGICAL BACKGROUND

To highlight the conventional display components, some watches comprise a dial with a three-dimensional decoration on the visible face that gives the watch a distinctive personality. This type of decoration typically comprises reliefs with geometric shapes. A dial of this type is typically manufactured using processes that include a step of machining into the base material of the dial, such as copper, iron or aluminium alloys, polymers, stone, ceramics or any other material known to a person skilled in the art, to obtain the three-dimensional shape, followed by polishing, enameling and/or colouring steps.

However, these processes remain unsatisfactory in view of the increasingly stringent requirements in terms of the aesthetic appearance of the dials and the potential presence of defects or burrs on these dials following the grinding and colouring steps. Moreover, the decorative possibilities offered by existing processes are limited to a restricted choice from among a few old and well-known processes, which does not allow dials to be produced with an original decoration.

In this context, there is thus a need to find a solution to improve the prior art.

### SUMMARY OF THE INVENTION

The general aim of the invention is to provide an improved and simplified solution for manufacturing an aesthetically pleasing dial comprising a three-dimensional decoration, and which does not include all or some of the drawbacks of the prior art.

To this end, the invention relates to a method for manufacturing a watch dial comprising a visible face having a small surface area, said face comprising a three-dimensional representation of a landscape, in particular a topographic map of this landscape, the method comprising the following steps of:
producing a blank of this dial comprising an upper face provided with a three-dimensional structure relating to said three-dimensional representation of the landscape, said blank production step comprising a sub-step of generating topographic data for constructing said three-dimensional structure in this upper face;
treating a surface of this three-dimensional structure of the upper face of the blank during which at least one visual feature of this surface is modified in anticipation of obtaining the three-dimensional representation;
finishing the blank to obtain the dial.

In other embodiments:
the generation sub-step comprises a phase of obtaining said topographic construction data by processing raw topographic data relating to said landscape, which processing operation is performed by a topographic construction data generation algorithm executed by a controller of a system for generating such data;
said obtaining phase implementing computations for determining the topographic construction data as a function of the dimensions of the surface of the upper face of the blank, the essential shape of this surface, the nature of the material of the substrate constituting this blank and visual features, perceived by an observer, of the three-dimensional structure of the upper face constituting the three-dimensional representation of said landscape;
said obtaining phase implementing an operation for modifying the values of the raw topographic data, resulting in a variation in the dimensions of different zones of this structure, namely flat, raised and/or recessed zones;
the production step comprises a sub-step of producing the three-dimensional structure in the upper face of the blank, said sub-step comprising a phase for patterning the upper face of the blank on the basis of the topographic construction data obtained;
the treatment step comprises a sub-step of modifying the surface condition of all or part of the three-dimensional structure;
the treatment step comprises a sub-step of depositing a coating on the surface of all or part of the three-dimensional structure;
a step of creating at least one pattern on the treated surface of the three-dimensional structure;
a step of encapsulating all or part of the surface of the three-dimensional structure;
said landscape reproduced is a real landscape and/or an existing landscape;
the surface area of the small surface is between 700 and 1700 mm².

Another aspect of the invention relates to a dial having a visible face comprising a three-dimensional representation of a landscape, which dial can be obtained using such a method.

Another aspect of the invention relates to a watch comprising such a dial.

Advantageously, the watch is a wristwatch.

### BRIEF DESCRIPTION OF THE FIGURES

Other features and advantages of the invention will become clearer on reading the following description of a particular embodiment of the invention, which is given merely as an illustrative and non-limiting example, and of the accompanying figures, among which:

FIG. 1 shows, in the form of a flow chart, the essential steps of a method for manufacturing a dial for a watch, the dial comprising a visible face provided with a decoration comprising a three-dimensional representation of a landscape, which landscape can be real or existing, according to one embodiment of the invention;

FIG. 2 shows the watch comprising such a dial according to the embodiment of the invention;

FIG. 3 is a sectional view, along the line III-III, of the watch dial, according to the embodiment of the invention;

FIG. 4 is a view similar to that of FIG. 3, this time of a blank of the dial provided with a three-dimensional structure relating to the three-dimensional representation of the landscape, according to the embodiment of the invention;

FIG. 5 is a view similar to that of FIG. 4, of the blank with a coating covering a surface of the three-dimensional structure, according to the embodiment of the invention;

FIG. 6 is a view similar to that of FIG. 5 of the blank comprising a pattern on the surface coating of the three-dimensional structure, according to the embodiment of the invention.

### DETAILED DESCRIPTION OF THE INVENTION

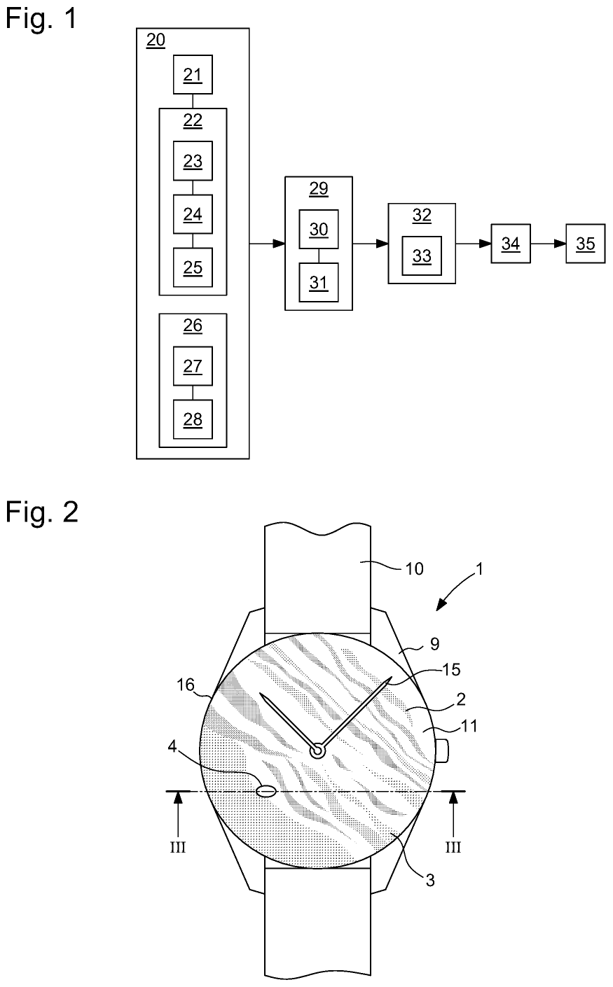

With reference to FIGS. 1 to 6, the invention relates to a method for manufacturing a dial 2 of a watch 1. Such a watch 1 is in particular a wristwatch including a case 16 housing a movement and a display device comprising this dial 2 and hands 15. This wristwatch 1 is worn around the wrist of the wearer of this watch 1.

The case 16 of this watch 1 further comprises a middle 9 to which a bracelet 10 is connected. In this watch 1, such a dial 2 is arranged in the case 16 and comprises a visible face 11 having a small surface area. Such a surface has very small dimensions. This small surface area is preferably between 700 and 1700 mm². This surface is restricted by the case 16 of the watch 1. In other words, this surface is said to be restricted by this case 16 because the dial 2, or the visible face 11, is surrounded by an inner peripheral wall of an enclosure of this case 16. It is understood that the dial 2 of the invention is a watch dial, i.e. it is configured to be mounted in an object, in this case the watch, which is intended to be carried/worn by an individual when travelling without the operation of this watch being altered.

This dial 2 is characterised in that it comprises a visible face 11 provided with a three-dimensional decoration comprising a three-dimensional representation 3, more precisely a representation of a topographic map relating to a landscape. In other words, this three-dimensional representation 3 is a topographic map 3 of a landscape.

Such a landscape is preferably a real or existing landscape present in nature. This landscape is made up of all of the elements that can be observed from a specific location. In other words, it is the visible appearance of a geographical space. Such a landscape can be, in a non-limitative and non-exhaustive way, a terrestrial landscape such as a mountain range or an underwater landscape such as an ocean trench. Such a landscape can include, but is not limited to, reliefs, cavities, the presence of water and/or vegetation, etc.

As already mentioned, the three-dimensional representation 3 of this landscape is produced on the visible face 11 of this dial 2. This visible face 11 corresponds to the face of the dial 2 which will be observable by/visible to the user wearing such a watch 1 when this dial 2 is mounted in the case 16 of the watch 1.

The three-dimensional representation 3 of this landscape produced on/in this visible face 11 is faithful to the real or existing landscape which it works to reproduce on this dial 2 in the form of the topographic map. In fact, the reproduction of this existing landscape on this dial 2 is based on topographic data corresponding to or describing this landscape. Such data can be referred to as “topographic landscape data” or “raw topographic data”.

Such data include measurements from a topographic survey. These measurements have been collected directly on the ground in relation to this landscape, with a view to their transcription on this dial 2 in particular. Such measurements include, but are not limited to, two components:
a planimetric component measured during a planimetric survey to determine the position of a point in a horizontal plane, and
an altimetric component measured during an altimetric survey which gives the position of the same point above or below a horizontal reference plane.

It should be noted that this three-dimensional representation 3 is produced over substantially the entire surface of the visible face 11 of this dial 2. More specifically, this representation 3 is produced over 80% or 90% of this surface of the visible face 11 or even over the entire surface of the visible face 11. In other words, this three-dimensional representation 3 occupies between 15% and 100% of the visible face 11 of this dial 2.

Such a reproduction of this landscape on the dial 2 is said to be reversible because it constitutes a faithful/exact representation 3 of this landscape scaled to the dimensions of the dial 2 of the watch 1, while precisely respecting these topographic data. In other words, the real dimensions of the constituent elements of the landscape reproduced on this dial 2 can be obtained from measurements taken directly from this three-dimensional representation 3, and this landscape can be reproduced to another scale while remaining faithful to the real dimensions of this landscape.

In the present embodiment, the manufacturing method then comprises a step 20 of producing a blank 12 of this dial 2 of the watch 1, said blank 12 comprising a three-dimensional structure 5 relating to said three-dimensional representation 3 of the landscape.

It should be noted that in this blank 12, the upper face 13 corresponds to the visible face 11 of the dial 2 to be manufactured.

Such a step 20 comprises a sub-step 21 of providing a substrate constituting this blank 12. This substrate preferably has the final shape and dimensions of the dial 2 to be manufactured. Such a substrate is made of a rigid material. This material can be a metallic material, a metallic alloy type material and/or a technical ceramic type material. This substrate can, for example, be made of a copper alloy, stainless steel, precious metals, titanium, alumina, doped or undoped strontium aluminate, stabilised or unstabilised zirconia, a hybrid organic-inorganic material or, in general, any metal alloy or any technical ceramic or any composite that can be used in the field of watchmaking. The term “technical ceramic” is understood to mean dense materials based on aluminium oxide and/or zirconium oxide and/or stabilised zirconium oxide and/or nitrides and/or carbides and/or strontium aluminate, in particular doped strontium aluminate. The term “dense” is understood to mean a material with a density of between 95% and 100% of the theoretical density of the material in question. The expression “based on a certain compound” means that the material comprises at least 50% by weight of said compound.

This production step 20 also comprises a sub-step 22 of generating topographic data for constructing the three-dimensional structure 5 in the upper face 13 of the blank 12. With reference to FIG. 4, this three-dimensional structure 5 comprises:
at least one flat zone 6a; and/or
at least one raised zone 6b, i.e. comprising at least one relief;
and/or
at least one recessed zone 6c, i.e. comprising at least one recess; this recess can also be referred to as a rib.

It should be noted that these zones 6a, 6b, 6c are defined in relation to a reference surface of the blank 12. This reference surface is small and flat and is included in the upper face 13 of the blank 12 when the latter has not yet been modified to produce the three-dimensional structure 5. This reference surface lies in a plane P visible in FIG. 4. In this configuration, the flat zone 6a is included in the reference surface and thus lies in the plane P, the raised zone 6b above the reference surface and the recessed zone 6c below this surface.

Such a sub-step 22 is implemented by a system for generating these topographic data for constructing the three-dimensional structure 5. This system comprises, in a non-exhaustive and non-limiting manner, a controller and a communication module as well as a database comprising the topographic landscape data, also referred to as raw topographic data.

In this system, the controller, also referred to as the processing unit, comprises an electronic circuit including hardware resources, in particular at least one processor cooperating with memory elements as well as address, data and control buses. This controller includes, in its memory elements, an algorithm for generating topographic data for constructing the three-dimensional structure 5. Such an algorithm is executed by the processor of this controller taking into account computation criteria such as the surface area of the upper face 13 of the blank 12, the essential shape of this face 13, the dimensions of this face 13 and/or the nature of the material of the substrate constituting this blank 12. These criteria can further include visual features, perceived by an observer, of the three-dimensional structure of the upper face 13 constituting the three-dimensional representation 3 of said landscape. It should be noted that such an algorithm, by being applied to the raw topographic data, contributes in particular to scaling the three-dimensional representation 3 of the landscape to predetermined dimensions, namely the dimensions of the blank 12 and in particular those of its upper face 13.

This controller is connected to the database via the communication module. For this purpose, the communication module, which is connected to the controller, comprises wired or wireless connection elements connecting it to the database.

In this context, the generation sub-step 22 comprises a phase 23 of retrieving the raw topographic data on the landscape to be used for producing the three-dimensional structure 5 in the upper face 13 of the blank 12. During this phase 23, the controller thus retrieves this raw topographic data by establishing a connection with the database containing such topographic data relating to the landscape to be patterned on this blank 12.

This sub-step 22 then comprises a phase 24 of obtaining the topographic construction data by processing raw topographic data relating to said landscape, the processing operation being carried out by the algorithm which is executed by the controller. More specifically, during this phase 24, the controller thus performs computations on the raw topographic data by executing said algorithm. The purpose of such computations is to obtain the topographic construction data taking account in particular of the surface area of the upper face 13 of the blank 12, the essential shape of this surface, the nature of the material of the substrate constituting this blank 12 and visual features, perceived by an observer, of the three-dimensional structure 5 of the upper face 13 constituting the three-dimensional representation 3 of said landscape. These perceived visual features help to improve the visual rendering of this structure 5 of the upper face 13 to be produced. These features relate to, for example, the accentuation or improvement of the contrast perceived by an observer viewing this three-dimensional structure 5 by modifying the values of the raw topographic data in order to vary the dimensions of the different zones 6a, 6b, 6c of this structure 5, namely the flat zones 6a, the raised zones 6b and/or the recessed zones 6c. By way of example, the algorithm can increase the contrasts in at least one flat zone 6a of the structure 5 by modifying in a balanced manner at least one recessed zone 6c and/or at least one raised zone 6b relative to the average of the zones 6a to 6c located around said at least one modified zone 6b, 6c. In this context, said at least one modified zone 6b, 6c, i.e. in this case said at least one recessed zone 6c and said at least one raised zone are modified in depth and height/altitude respectively.

Such topographic construction data each include spatial measurement information in three perpendicular axes X, Y and Z, with the horizontal axes X and Y, and the Z axis being a vertical axis. Within the scope of the invention, this information relates to the longitude on the X axis, the latitude on the Y axis and the altitude/height of a relief or the depth of a recess on the Z axis. These topographic construction data are used to model the three-dimensional structure 5 to be formed in the upper face 13 of the blank 12. Such modelling of the three-dimensional structure 5 corresponds to the digital representation of this structure 5. This modelling comprises a cloud of points forming the three-dimensional structure 5 of the blank 12. In this context, each piece of topographic construction data is a spatial coordinate of a point in this cloud.

As mentioned previously, the algorithm executed by the controller is involved in obtaining the topographic construction data. In this context, this algorithm is configured to implement mathematical functions, in particular:
polynomial functions in the z axis;
mathematical functions configured to increase or decrease a z-coordinate as a function of the n^{th}-order average in z of the neighbouring x and y coordinates;
polynomial functions in the variable z axis according to derivatives/slopes of surfaces.

Sub-step 22 then provides for a phase 25 of archiving these topographic construction data, and thus this model, in a computer/digital file stored in the memory elements of the controller.

The production step 20 further comprises a sub-step 26 of producing the three-dimensional structure 5 in/on the upper face 13 of the blank 12. Such a sub-step 26 is implemented in particular by a system for producing this structure 5 in this upper face 13 of the blank 12. This system comprises a control unit, a communication module and a device for patterning the upper face 13. This patterning device, which is driven by the control unit, can comprise a mechanical machining and/or laser machining module, or a module for stamping on blanks 12 of the dial 2. In this context, the production step 20 can comprise a sub-step of machining the upper face 13 by precision laser engraving using a femtosecond laser.

In this context, sub-step 26 comprises a phase 27 of receiving the computer/digital file comprising the topographic construction data, and thus the modelling of the three-dimensional structure 5 in the upper face 13 of the blank of the dial 2. During this phase 27, the controller of the system for generating topographic construction data transmits the computer/digital file to the control unit via the communication modules of these two systems.

This sub-step 26 then comprises a phase 28 of patterning the upper face 13 of the blank 12 on the basis of the topographic construction data included in the file received. With reference to FIG. 4, during this phase 28, the control unit generates instructions for driving the machining module on the basis of these topographic construction data, in order to produce the three-dimensional structure 5 in the upper face of the blank 12. These control instructions allow the machining module to be guided in/on the upper face 13 of the blank 12 in order to reproduce the three-dimensional structure 5 point by point, so that it conforms to its model.

It should be noted that in an alternative embodiment where this three-dimensional structure 5 is produced by the stamping module, this module comprises a die provided with an impression relating to this structure 5. More specifically, this impression can be made by the machining module on the basis of control instructions allowing this machining module to be guided in/on the face of this die intended to receive such an impression.

It should be noted that the thickness e1 of this three-dimensional structure, produced in the upper face of the blank visible in FIG. 4, is preferably between 10¹ and 10³ μm.

Such a three-dimensional structure 5 is produced over substantially the entire upper face 13 of this blank 12. More specifically, this structure 5 is produced over 80% or 90% of this upper face 13 or even over the entire upper face 13. In other words, this three-dimensional structure 5 occupies between 15% and 100% of the upper face 13.

The method then comprises a step 29 of treating the surface 14 of the three-dimensional structure 5 of the blank 12 during which at least one visual feature of this surface 14 is modified. The purpose of this step 29 is to shape/modify the visual features of this surface 14 including, in a non-limitative and non-exhaustive manner, the degree of roughness, the degree of brilliance and/or the colour of this surface 14. More specifically, this step 29 makes it possible to modify at least one of these features over the whole of this surface 14 or over at least a portion of this surface 14.

This treatment step 29 contributes to modifying the optical properties (e.g. light reflection, light distribution on this surface 14, etc.) and the aesthetic properties of this surface 14 of the structure 5 in order to improve the visual perception of the various zones 6a, 6b, 6c that make it up, in particular by helping to make the details of the landscape reproduced by this three-dimensional structure 5 visible.

To do this, this step 29 includes a sub-step 30 of modifying the surface condition 14 of all or part of the three-dimensional structure 5 and a sub-step 31 of depositing a coating 7 on the surface 14 of all or part of the three-dimensional structure 5. The modification sub-step 30 can be implemented either before or after the deposition sub-step 31 depending on the treatment to be applied to the surface 14 of this structure 5 or to at least one of the portions constituting such a surface 14.

The purpose of the modification sub-step 30 is to modify the features of this surface 14 including, in a non-limitative and non-exhaustive manner, the degree of roughness and/or the degree of brilliance and/or the colour of this surface 14. During such a sub-step 30, operations for treating the surface 14 are carried out, such as dry sandblasting, wet sandblasting, shotblasting, sunray brushing, sanding, polishing, satin finishing, brushing, chemical etching or a combination of at least two of these operations. Such operations can be carried out on the entire surface 14 of the three-dimensional structure 5 or on at least a portion of this surface 14. In other words, such operations make it possible to selectively modify the surface 14 of this structure 5.

The purpose of the deposition sub-step 31 is to modify the colour feature of this surface 14. This sub-step 31 can also help to modify the degree of roughness and/or brilliance of this surface 14. During such a sub-step 31, operations for applying a coating 7 of metallic or resin-type material are carried out on this surface 14 or on at least one of the portions of this surface 14. In other words, such operations make it possible to selectively apply the coating 7 to the surface 14 of this structure 5. This coating 7 can be composed of a single layer or of a set of stacked layers in order to meet aesthetic and/or technical constraints. It should be noted that such a coating 7 has a thickness of between 10⁻² μm and 10² μm.

In the case of a metallic material, it can be applied by the dry or wet method using at least one of the following operations: PVD (Physical Vapour Deposition), CVD (Chemical Vapour Deposition), ALD (Atomic Layer Deposition), LBL (Layer by Layer), by ink-jet, by dip-coating, by brush, by a dispenser, by spraying, by nebulisation or by sol-gel process, by chemical process or by an electrochemical process of the electroplating type. It should be noted that such a metal material can be, for example, a metal alloy or a metal oxide. More specifically, this material can be, in a non-limitative and non-exhaustive manner, gold, silver, ruthenium, rhodium, nickel, copper, titanium, chromium, chromium oxide, titanium oxide or silicon oxide.

In the case of a resin-type material, it can be applied to the surface 14 of the three-dimensional structure 5 by at least one of the following operations: spraying, immersion or casting. Such a resin-type material can be transparent and/or coloured. This resin can be, but is not limited to, an acrylic, nitrocellulose, epoxy or polyurethane resin.

Subsequently, the method comprises a step 32 of producing at least one pattern 4 on the treated surface 14 of the three-dimensional structure 5. Such a step 32 comprises a sub-step 33 of printing material constituting said pattern 4. This material is made of a polymer such as a resin, and of particles. These particles can be organic, metallic, organometallic, rock, luminescent, phosphorescent or inert particles. The resin can be an acrylic, nitrocellulose, epoxy or polyurethane resin, but is not limited thereto. It should be noted that this printing sub-step 33 is carried out using transfer printing operations, also referred to as pad printing or transfer printing, or screen printing operations. It should be noted that such a pattern 4 can be two-dimensional or three-dimensional. More specifically, this pattern 4 is a graphic representation which can be, in a non-limitative and non-exhaustive manner, related to:
a marking element, such as a time-graduating numeral or index, involved in the production of a horological function such as the indication of a time or a date;
an inscription;
an image.

Such a pattern 4 can be an invisible pattern that can be revealed on demand. More specifically, it can be a fluorescent pattern that is only made visible when subjected to ultraviolet radiation.

Such a process also comprises a step 34 of encapsulating all or part of the surface 14 of the three-dimensional structure 5. During this step 34, an encapsulation layer 8 is applied over the entirety of this surface 14 or only over said at least one pattern 4. This layer 8 preferably has a thickness which is greater than that of the pattern 4. The thickness of such a layer is between 1 and 500 μm. Such an encapsulation layer 8 is preferably formed by a resin such as an epoxy resin. Alternatively, this resin can be an acrylic, nitrocellulose or polyurethane resin. It should be noted that the application of such a layer 8 to this surface 14 helps in particular to protect it against wear over time and to improve the visual appearance of the three-dimensional structure 5 by giving it depth. Moreover, such a layer 8 helps to improve robustness, as the dials decorated in this way are likely to be external components subjected to impacts and to a sometimes aggressive environment (humidity, dust, etc.).

The method then comprises a step 35 of finalising/finishing the blank 12 in order to obtain this dial 2. During this step 35, finishing operations are carried out such as:
an operation of machining the blank in order to size, if necessary, this blank 12 for its assembly in the case 13 of the watch 1;
a machining operation carried out on the dial 2 to produce a through opening for the passage of a shaft for driving the hands 15;
an operation for polishing the blank 12;
a galvanic treatment operation to protect the exposed parts of the blank 12, i.e. the parts of the substrate that were revealed during the machining operation;
a transfer operation directly on the encapsulation layer using an acrylic, nitrocellulose, polyurethane or epoxy resin;
an applique/index fitting operation if this has not yet been carried out. These appliques can be bonded directly onto the blank or bonded via parts passing through the dial through holes created during the machining operation.

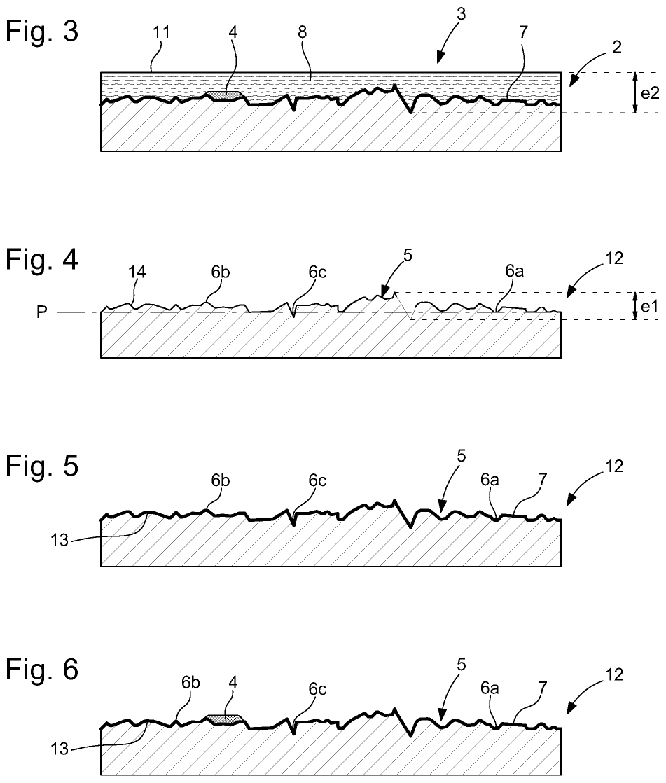

Such a method can thus be used to manufacture a dial 2 comprising a decoration present on its visible face 11 consisting of the detailed reproduction of a landscape on the basis of topographic data relating to this landscape. This decoration comprises the three-dimensional representation 3 having a thickness e2, visible in FIG. 3, which is preferably between 10¹ μm and 10⁴ μm, preferably 10³ μm.

### Nomenclature

1. Watch
2. Dial
3. Three-dimensional decor, three-dimensional representation
4. Pattern
5. Three-dimensional structure
6a. Flat zone
6b. Raised zone
6c. Recessed zone
7. Coating
8. Encapsulation layer
9. Middle
10. Bracelet
11. Visible face
12. Dial blank
13. Upper face of the blank
14. Surface of the three-dimensional structure
15. Hands
16. Case

1. A method for manufacturing a dial (2) of a watch (1) including a visible face (11) having a small surface, said face (11) comprising a three-dimensional representation (3) of a landscape, in particular a topographic map of the landscape, the method comprising the following steps of:
producing (20) a blank (12) of the dial (2) comprising an upper face (13) provided with a three-dimensional structure (5) relating to said three-dimensional representation (3) of the landscape, said production step (20) comprising a sub-step (22) of generating topographic data for constructing said three-dimensional structure (5) in the upper face (13);
treating (29) a surface (14) of the three-dimensional structure (5) of the upper face (13) of the blank (12) during which at least one visual feature of the surface (14) is modified in anticipation of obtaining the three-dimensional representation (3);
finishing (35) the blank (12) to obtain the dial (2).

2. The method according to claim 1, wherein the generation sub-step (22) comprises a phase (24) of obtaining said construction topographic data by processing raw topographic data relating to said landscape, which processing operation is performed by a topographic construction data generation algorithm executed by a controller of a system for generating such data.

3. The method according to claim 1, wherein the generation sub-step (22) comprises a phase (24) of obtaining said construction topographic data implementing computations for determining the topographic construction data as a function of the dimensions of the surface of the upper face (13) of the blank (12), of the essential shape of the surface, of the nature of the material of the substrate constituting the blank (12) and of visual features, perceived by an observer, of the three-dimensional structure (5) of the upper face (13) constituting the three-dimensional representation (3) of said landscape.

4. The method according to claim 1, wherein said obtaining phase (24) implements an operation for modifying the values of the raw topographic data, giving rise to a variation in the dimensions of different zones (6a, 6b, 6c) of the structure (5), namely flat (6a), raised (6b) and/or recessed (6c) zones.

5. The method according to claim 1, wherein the production step (20) comprises a sub-step (26) of producing the three-dimensional structure (5) in the upper face (13) of the blank (12), said sub-step (26) comprising a phase (28) for patterning the upper face (13) of the blank (12) on the basis of the topographic construction data obtained.

6. The method according to claim 1, wherein the treatment step (29) comprises a sub-step (30) of modifying the surface condition (14) of all or part of the three-dimensional structure (5).

7. The method according to claim 1, wherein the treatment step (29) comprises a sub-step (31) of depositing a coating (7) on the surface (14) of all or part of the three-dimensional structure (5).

8. The method according to claim 1 further comprising a step (32) of creating at least one pattern (4) on the treated surface (14) of the three-dimensional structure (5).

9. The method according to claim 1 further comprising a step (34) of encapsulating all or part of the surface (14) of the three-dimensional structure (5).

10. The method according to claim 1, wherein said reproduced landscape is a real landscape and/or an existing landscape.

11. The method according to claim 1, wherein the surface area of said small surface is between 700 and 1700 mm².

12. A dial (2) having a visible face (11) comprising a three-dimensional representation (3) of a landscape, which dial is obtained using the method according to claim 1.

13. A watch (1) including the dial (2) according to claim 12.

14. The watch (1) according to claim 13, which watch is a wristwatch.
